(19) United States
(12) Patent Application Publication
(10) Pub. No.: US 2010/0287752 A1
(43) Pub. Date: Nov. 18, 2010

(54) RIVET SYSTEM

(76) Inventor: Stanley Wojciechowski, Waco, TX (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/466,204

(22) Filed: May 14, 2009

(51) Int. Cl. B23P 11/00

(52) U.S. Cl. 29/243.53

(57) ABSTRACT

A rivet system having a rivet and an installation anvil, wherein the rivet has a hollow body portion and a head portion, wherein the hollow body portion has a first and a second ends, wherein the hollow body near the second end is sufficiently designed to pierce work pieces during a joining process, wherein the installation anvil having a head portion which is sufficiently designed so that, when the rivet is pushed toward work pieces, the head portion pushes a slug from each work piece into a cavity of the hollow body of the rivet, and wherein the head portion of the installation anvil is sufficiently designed so that the head portion of the installation anvil forces the second end of the hollow body of the rivet to change its shape.

### BACKGROUND OF THE INVENTION

This invention is related to a rivet of a particular design and a rivet setting process.

### BRIEF SUMMARY OF THE INVENTION

The present invention is related to a rivet system having a rivet and an installation anvil. The invention is also related to various methods of joining work pieces with a rivet designed in accordance with at least one embodiment of the present invention.

An embodiment of the rivet system, a rivet joins at least a first and a second work pieces.

In an embodiment of the rivet system, the rivet has a hollow body portion and a head portion. In an embodiment of the rivet system, the hollow body portion has a first and a second ends. In an embodiment of the rivet system, the head portion is further positioned at the first end of the hollow body portion. In an embodiment of the rivet system, the second end of the hollow body of the rivet faces the first work piece. In an embodiment of the rivet system, the hollow body near the second end is sufficiently designed to pierce work pieces during a joining process.

An embodiment of the rivet system further comprises an installation anvil having a head portion. In an embodiment of the rivet system, the head portion of the installation anvil is further sufficiently designed so that, when the rivet pierces the work pieces, to push a slug from each work piece into a cavity of the hollow body of the rivet. In an embodiment of the rivet system, the slugs is composed of portions of the first and the second work pieces which are pierced through by the second end of the hollow body of the rivet during the joining process. In an embodiment of the rivet system, the head portion of the installation anvil is sufficiently designed so that, when the second end of the hollow body of the rivet pierces the second work piece, the head portion of the installation anvil forces the second end of the hollow body to change its shape.

In an embodiment of the rivet system, the installation anvil is stationary.

In an embodiment of the rivet system, the second end of the hollow body of the rivet is narrowed at an angle to create a pointed ending.

In an embodiment of the rivet system, the rivet system further comprises a plunger which presses onto the head of the rivet, forcing the rivet to pierce the work pieces.

In an embodiment of the rivet system, the rivet system further comprises a top and a bottom holding dies which clam the work pieces together during the joining process.

In an embodiment of the rivet system, the head portion of the installation anvil extends towards the work pieces beyond a boundary of the bottom holding die.

In an embodiment of the rivet system, the hollow body of the rivet is sufficiently designed to outwardly bow during the joining process.

In an embodiment of the rivet system, the rivet is made from a material whose tensile strength is higher than tensile strength of the first and second work pieces.

In an embodiment of the rivet system, at least a portion of a wall of the hollow body of the rivet is sufficiently designed so that, when the wall is being pressed on by the slugs or the head portion of the installation anvil, the wall changes its shape to form sequential areas of outward and inward deformities with respect to the cavity of the hollow body.

### BRIEF DESCRIPTION OF THE SEVERAL VIEWS OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 shows a cross section of an embodiment of the rivet system.

FIG. 2 shows a cross section of an installation step when using an embodiment of the rivet system.

FIG. 3 shows a cross section of an installation step when using an embodiment of the rivet system.

FIG. 4 shows a cross section of an installation step when using an embodiment of the rivet system.

FIG. 5 shows a cross section of an installation step when using an embodiment of the rivet system.

FIG. 6 shows a cross section of an installation step when using an embodiment of the rivet system.

FIG. 7 shows a cross section of an installation step when using an embodiment of the rivet system.

FIG. 8 shows a cross section of an installation step when using an embodiment of the rivet system.

FIG. 9 shows a cross section of an installation step when using an embodiment of the rivet system.

FIG. 10 shows a cross section of an installation step when using an embodiment of the rivet system.

FIG. 11 shows a cross section of an installation step when using an embodiment of the rivet system.

FIG. 12 shows a cross section of an installation step when using an embodiment of the rivet system.

FIG. 13 shows a cross section of an installation step when using an embodiment of the rivet system.

FIG. 14 shows a cross section of an installation step when using an embodiment of the rivet system.

FIG. 15 shows a cross section of an installation step when using an embodiment of the rivet system.

### DETAILED DESCRIPTION OF THE INVENTION

Detailed embodiments of the present invention are disclosed herein; however, it is to be understood that the disclosed embodiments are merely illustrative of the invention that is embodied in various forms. In addition, each of the examples given in connection with the various embodiments of the invention are intended to be illustrative, and not restrictive. Further, the figures are not necessarily to scale, some features is exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

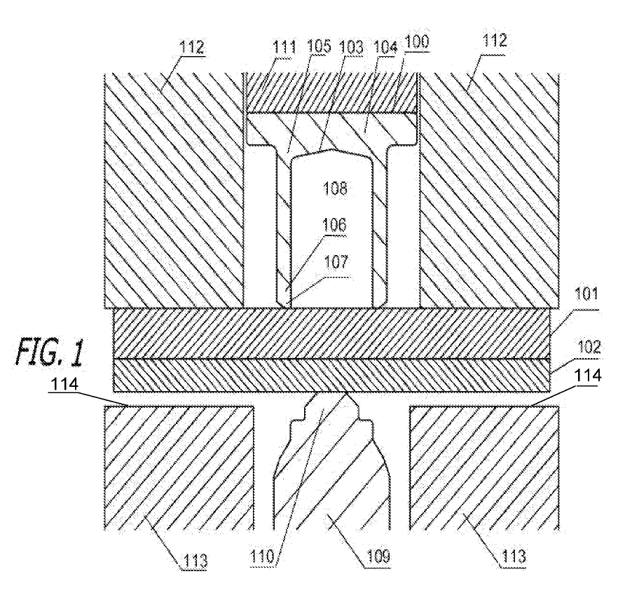

FIG. 1 shows a cross section of an embodiment of the rivet system. An embodiment of the rivet system comprises a rivet 100 to join at least a first 101 and a second work pieces 102. In an embodiment, the rivet 100 has a hollow body portion 103 and a head portion 104. In an embodiment, the hollow body portion 103 has a first 105 and a second 106 ends. In an embodiment, the head portion 104 is further positioned at the first end 105 of the hollow body portion 103. In an embodiment, the second end 106 of the hollow body 103 of the rivet faces the first work piece 101. In an embodiment, the hollow body 103 near the second end 106 is sufficiently designed to pierce the work pieces 101, 102 during a joining operation. In an embodiment, the second end 106 of the hollow body of the rivet is narrowed at an angle to create a pointed ending 107. In an embodiment, the hollow body has a cavity 108.

An embodiment of the rivet system further comprises an installation anvil 109 having a head portion 110. In an embodiment, the head portion 110 of the installation anvil 109 is sufficiently designed so that, when the rivet 100 is pierces the work pieces 101, 102, the head portion 110 of the installation anvil 109 pushes a slug from each work piece 101, 102 into the cavity 108 of the hollow body 103 of the rivet 100.

In an embodiment of the rivet system, the rivet system further comprises a plunger 111 which presses onto the head 104 of the rivet 100, forcing the rivet 100 to pierce the work pieces 101 and 102.

In an embodiment of the rivet system, the rivet system further comprises a top 112 and a bottom 113 holding dies which clam the work pieces 101 and 102 together during the joining operation.

In an embodiment, the head portion 110 of the installation anvil 109 extends beyond a boundary 114 of the bottom holding dies 113.

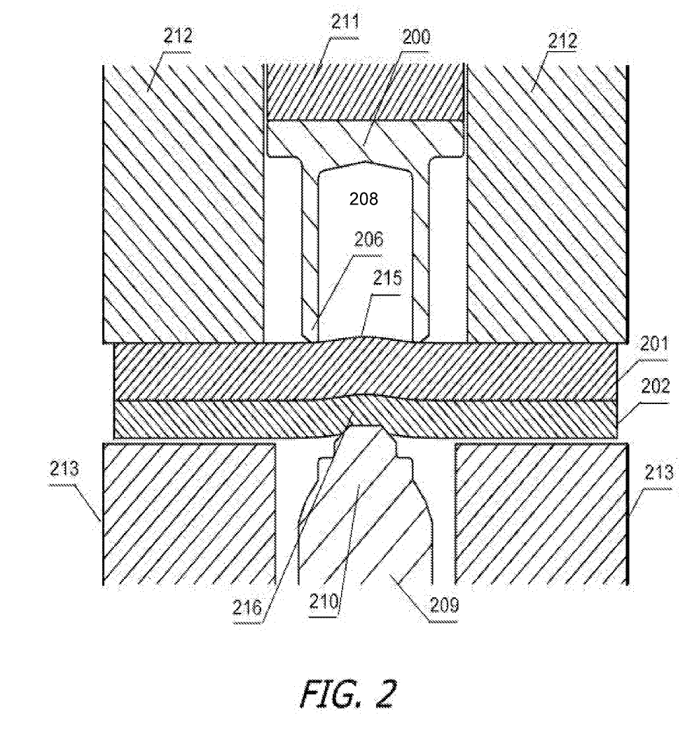

FIG. 2 shows a cross section of an installation step when using an embodiment of the rivet system. In an embodiment, a top 212 and a bottom 213 holding dies clam work pieces 201, 202 together. In an embodiment, an installation anvil 209 is stationary. In an embodiment, when the holding dies 212, 213 clam the work pieces 201 and 202, a head portion 210 of the installation anvil 209 is pressed against the bottom work piece 202, producing bulges 215, 216 of the corresponding work pieces 201 and 202. In an embodiment, a plunger 211 extends forward and pushes the rivet 200 toward work pieces 201 and 202. In an embodiment, an end 206 of the rivet 200 is narrowed at an angle to create a pointed ending that facilitates punching of the rivet 200 through the work pieces 201 and 202.

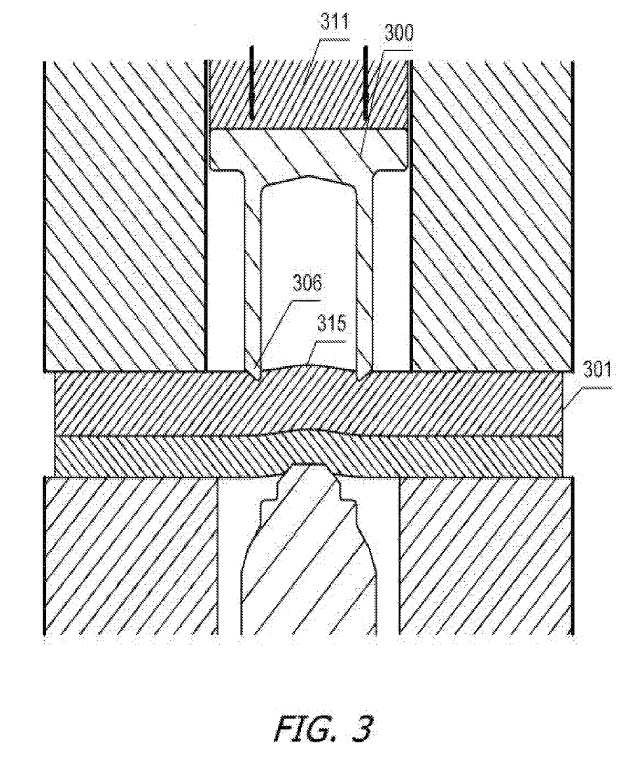

FIG. 3 shows a cross section of an installation step when using an embodiment of the rivet system. In an embodiment, a plunger 311 extends forward and pushes a rivet 300 toward a top work piece 301. In an embodiment, an end 306 of the rivet 300 pierces through a top work piece 301 around a bulge 315 when the plunger 311 pushes the rivet 300 toward the top work piece 301.

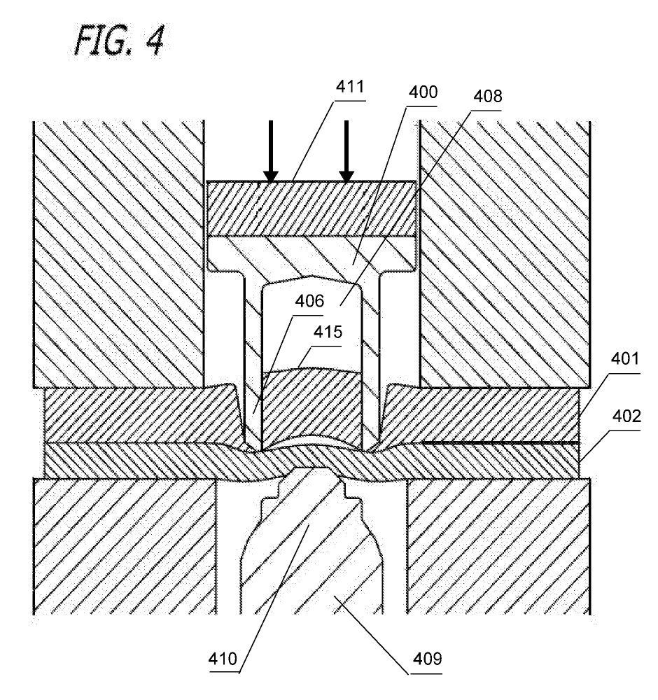

FIG. 4 shows a cross section of an installation step when using an embodiment of the rivet system. In an embodiment, a plunger 411 extends forward and pushes a rivet 400 toward a top work piece 401. In an embodiment, in response to the plunger 411 pushing the rivet 400, an end 406 of the rivet 400 pierces through the top work piece 401, producing a slug 415 of the top work piece 401. In an embodiment, since a head portion 410 of an installation anvil 409 continues to be pressed against a bottom work piece 402, the slug 415 is retained within a cavity 408 of the rivet 400. In an embodiment, as the plunger 411 continues to push onto the rivet 400 after the rivet 400 pierces through the top work piece 401, the end 406 of the rivet 400 continues to cut into the bottom work piece 402.

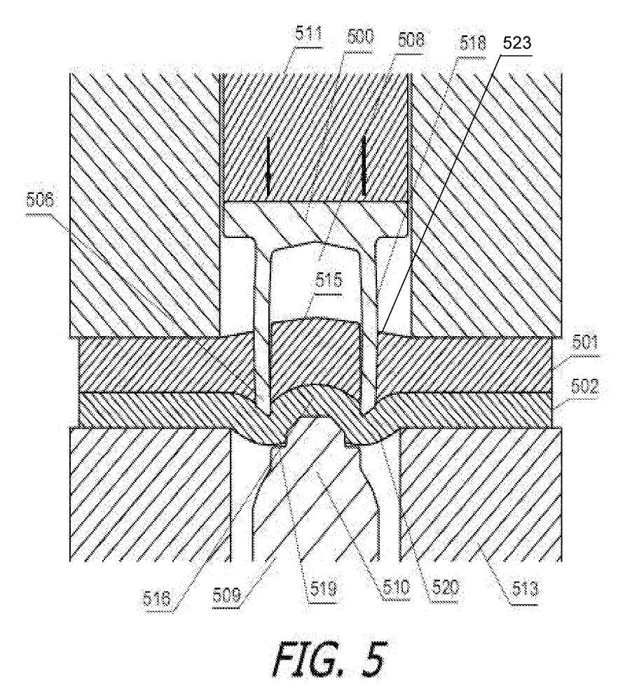

FIG. 5 shows a cross section of an installation step when using an embodiment of the rivet system. In an embodiment, a plunger 511 extends forward and pushes a rivet 500 toward a top work piece 501. In an embodiment, in response to the plunger 511 pushing the rivet 500, an end 506 of the rivet 500 pierces through the top work piece 501, producing a slug 515 of the top work piece 501. In an embodiment, since a head portion 510 of an installation anvil 509 continues to be pressed against a bottom work piece 502, the slug 515 is retained within a cavity 508 of the rivet 500. In an embodiment, as the plunger 511 continues to push the rivet 500 after the rivet 500 pierces through the top work piece 501, the end 506 of the rivet 500 continues to cut into the bottom work piece 502. In an embodiment, the head portion 510 of the installation anvil 509 has various surface shapes 519. In an embodiment, as the end 506 of the rivet 500 cuts into the bottom work piece 502, the area 516 of the bottom work piece 502 is being pushed up, toward the cavity 508 of the rivet 500, by the head portion 510 of the installation anvil 509. In an embodiment, the shape 519 of the head portion 510 impedes a movement of a part of a portion 516 of the bottom work piece 502, thus facilitating the piercing by the rivet 500 through the bottom work piece 502. In an embodiment, a pointed ending of the end 506 of the rivet 500 is designed to direct a movement of portions 523, 520 of the respective top and or the bottom work pieces. In an embodiment, the portions 520 of the bottom work piece 502 are also forced to curve around a bottom holding die 513. In an embodiment, during the piercing of the second work piece 502, due to an upward pressure created when the head portion 510 of the installation anvil 509 pushes up a portion 516 the bottom work piece 502, a wall 518 of the hollow body portion of the rivet 500 experiences a stress which causes the wall 518 to start bowing outward as the rivet 500 continues to cuts into the bottom work piece 502.

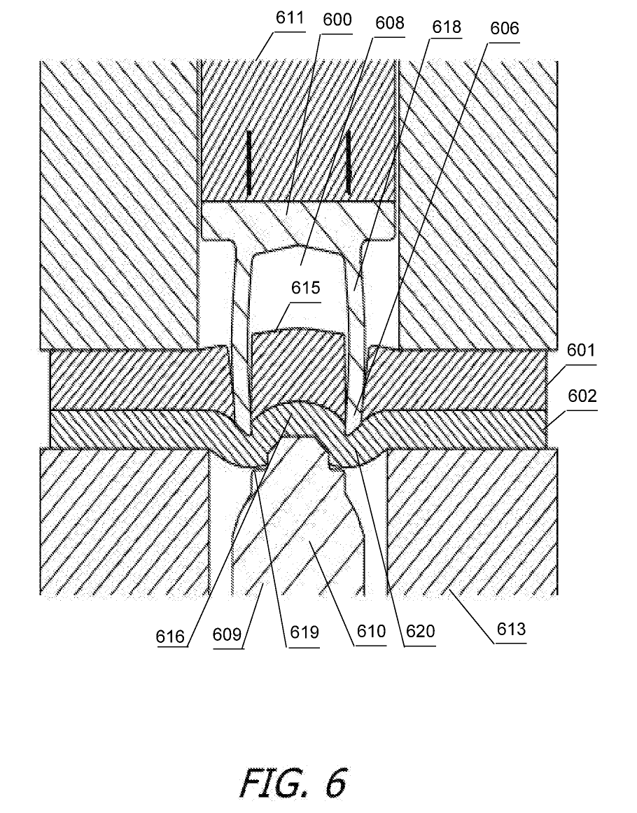

FIG. 6 shows a cross section of an installation step when using an embodiment of the rivet system. In an embodiment, a plunger 611 extends forward and pushes a rivet 600 toward work pieces 601, 602. In an embodiment, in response to the plunger 611 pushing the rivet 600, an end 606 of the rivet 600 pierces through the top work piece 601, producing a slug 615 from the top work piece 601. In an embodiment, since a head portion 610 of an installation anvil 609 continues to be pressed against a bottom work piece 602, the slug 615 is retained within a cavity 608 of the rivet 600. In an embodiment, as the plunger 611 continues to push the rivet 600 after the rivet 600 pierces through the top work piece 601, the end 606 continues to cut into the bottom work piece 602. In an embodiment, the head portion 610 of the installation anvil 609 has various surface shapes 619. In an embodiment, as the end 606 of the rivet 600 pierces through the bottom work piece 602, the area 616 of the bottom work piece 602 is being pushed up, toward the cavity 608 of the rivet 600, by the head portion 610 of the installation anvil 609. In an embodiment, the shape 619 of the head portion 610 impedes a movement of a part of a portion 620 of the bottom work piece 602, thus facilitating the piercing by the rivet 600 through the bottom work piece 602. In an embodiment, the portion 620 of the bottom work piece 602 are also forced to curve around a bottom holding die 613. In an embodiment, during the piercing of the bottom work piece 602, due to an upward pressure created when the head portion 610 of the installation anvil 609 pushes into the bottom work piece 602, a wall 618 of the hollow body portion of the rivet 600 experiences a stress which causes the wall 618 to bow outwardly as the rivet 600 pierces through the bottom work piece 602.

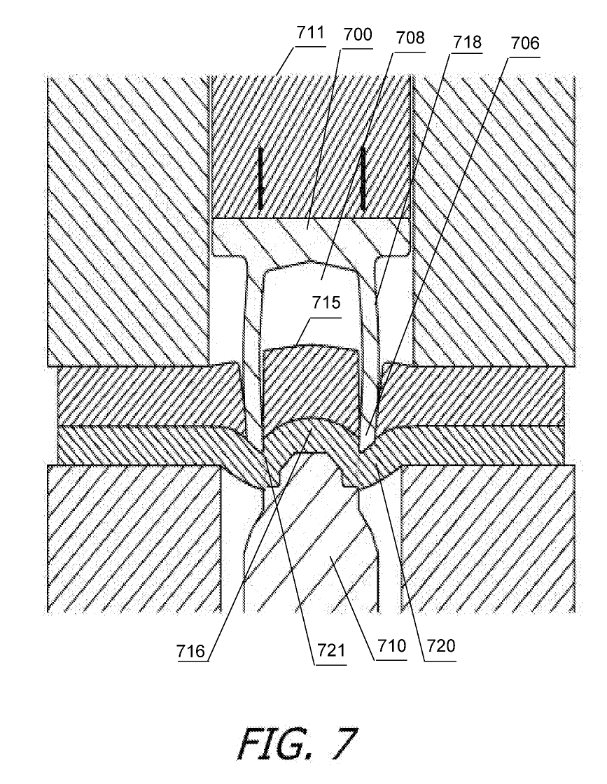

FIG. 7 shows a cross section of an installation step when using an embodiment of the rivet system. In an embodiment, as a plunger 711 continues to push a rivet 700. In an embodiment, when the upward pressure caused by the head portion 710 of the installation anvil and the downward pressure caused by the moving rivet 700 exceed stress characteristics of a material of the bottom work piece 702, the rivet pierces through the bottom work piece 702, in a break region 721, producing the slug 716. In an embodiment, the installation anvil further pushes a slug 715, which is formed when the rivet punches through a top work piece, and the slug 716 inside a cavity 708 of a hollow body of the rivet 700. In an embodiment, a wall 718 of the hollow body of the rivet 700 continues to bow outwardly as the wall 718 experiences an increased resistance during the piercing through the bottom work piece 702. In an embodiment, a top work piece is made from a material of a lesser tensile strength than a material from which the bottom work piece 702 is made. Tensile strength is the stress where necking begins and is the maxima of the stress-strain curve. Tensile strength is represented by (1) yield strength, (2) ultimate strength, and or (3) breaking strength. Yield strength is the stress at which material strain changes from elastic deformation to plastic deformation, causing it to deform permanently. Ultimate strength is the maximum stress a material can withstand when subjected to tension, compression or shearing. It is the maximum stress on the stress-strain curve. Breaking strength is the stress coordinate on the stress-strain curve at the point of rupture.

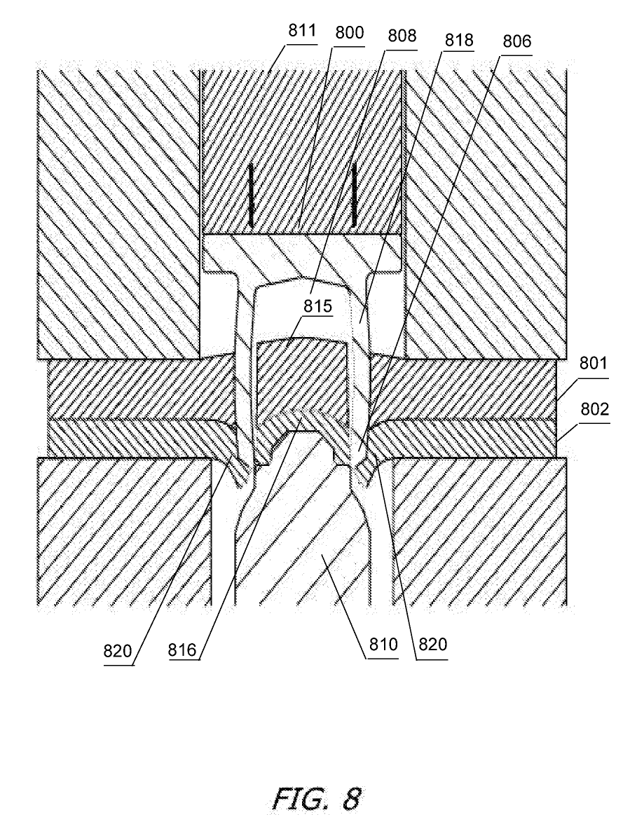

FIG. 8 shows a cross section of an installation step when using an embodiment of the rivet system. In an embodiment, as a plunger 811 continues to push a rivet 800, an end 806 of the rivet 800 pierces through a bottom work piece 802 and cuts off a slug 816. In an embodiment, a head portion 810 of an installation anvil pushes the slug 816 and a slug 815, from a top work piece 801, further into a cavity 808 of a hollow body of the rivet 800. In an embodiment, a wall 818 of the hollow body of the rivet 800 continues to bow outwardly as the wall 818 meets the head portion 810 of the installation anvil. As the wall 818 bows more outwardly, the wall 818 forms close contacts with regions of the top 801 and the bottom 802 work pieces that are adjacent to the wall 818. In an embodiment, the regions 820 of the bottom piece 802 which are being pressed on by the end 806 during piercing is dilated and pushed away from the installation anvil.

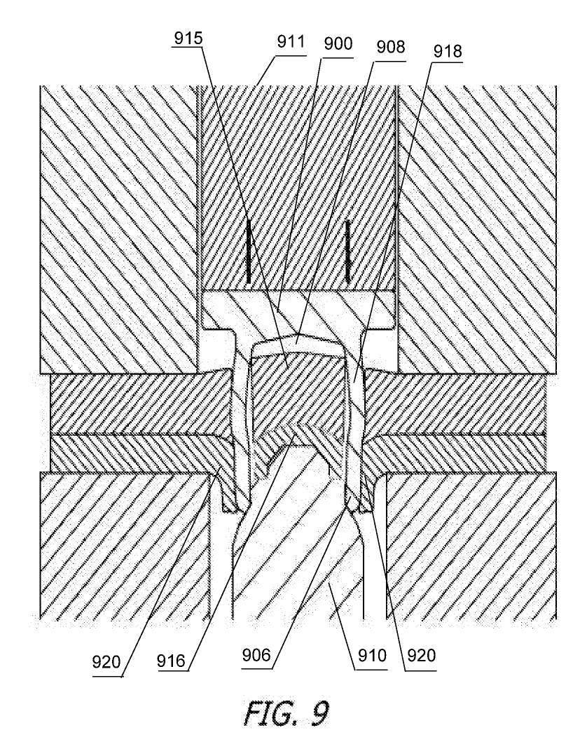

FIG. 9 shows a cross section of an installation step when using an embodiment of the rivet system. In an embodiment, as a plunger 911 continues to push a rivet 900. In an embodiment, a head portion 910 of an installation anvil pushes a slug 915 and a slug 916 even further into a cavity 908 of a hollow body of the rivet 900. In an embodiment, a wall 918 of the hollow body of the rivet 900 continues to bow outwardly as the wall 918 experiences a greater resistance while its moving along surfaces of the head portion 910 of the installation anvil. In an embodiment, regions 920 of the bottom work piece, which are pushed away from the head portion 910 of the installation anvil, form close contacts with the wall 918 of the rivet 900. In an embodiment, as the wall 918 moves along the surface of the head portion 910 of the installation anvil, an end 906 of the rivet 900 forms an outward flair, shaped by a design of the head portion 910.

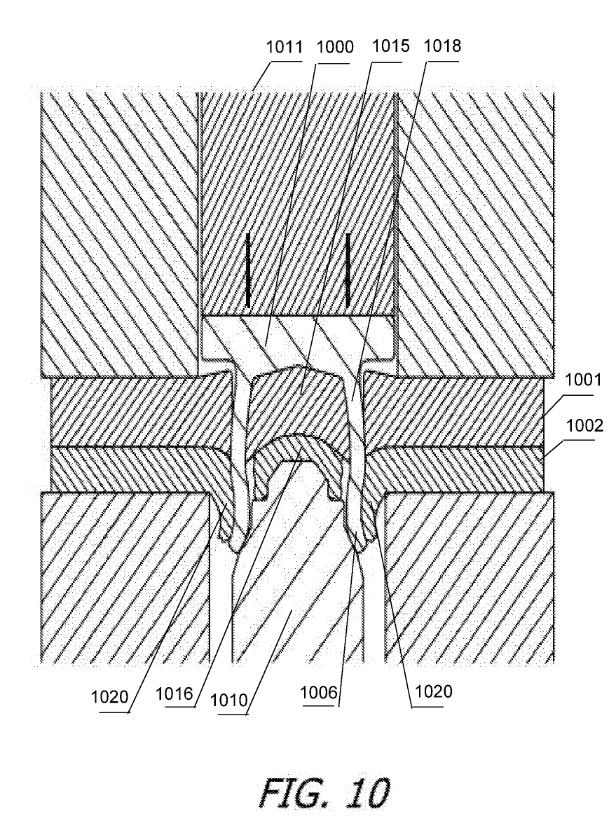

FIG. 10 shows a cross section of an installation step when using an embodiment of the rivet system. In an embodiment, as a plunger 1011 continues to push a rivet 1000. In an embodiment, a head portion 1010 of an installation anvil pushes a slug 1015 and a slug 1016 even further into a cavity of a hollow body of the rivet 1000. In an embodiment, the slug 1015 forms close contacts with internal surfaces of the cavity of the hollow body. In an embodiment, a wall 1018 of the hollow body continues to bow outwardly as the wall 1018 experiences a greater resistance while its moving along surfaces of the head portion 1010 of the installation anvil. In an embodiment, regions 1020 of the bottom work piece 1002, which are pushed away from the head portion 1010 of the installation anvil, form close contacts with the wall 1018. In an embodiment, as the wall 1018 moves along the surface of the head portion 1010 of the installation anvil, an end 1006 continues to experience an outward flair, forming a retention curvature. In an embodiment, a geometry of the outward flair depends on a design of the head portion 1010, a design of the end 1006, and or characteristics of the regions 1020 of the bottom work piece 1002. In an embodiment, the head portion 1010 of the installation anvil is designed to cause an outward rollover or stretching of the end 1006. In an embodiment, the outward flair and or the outward rollover increases a stability of a joint.

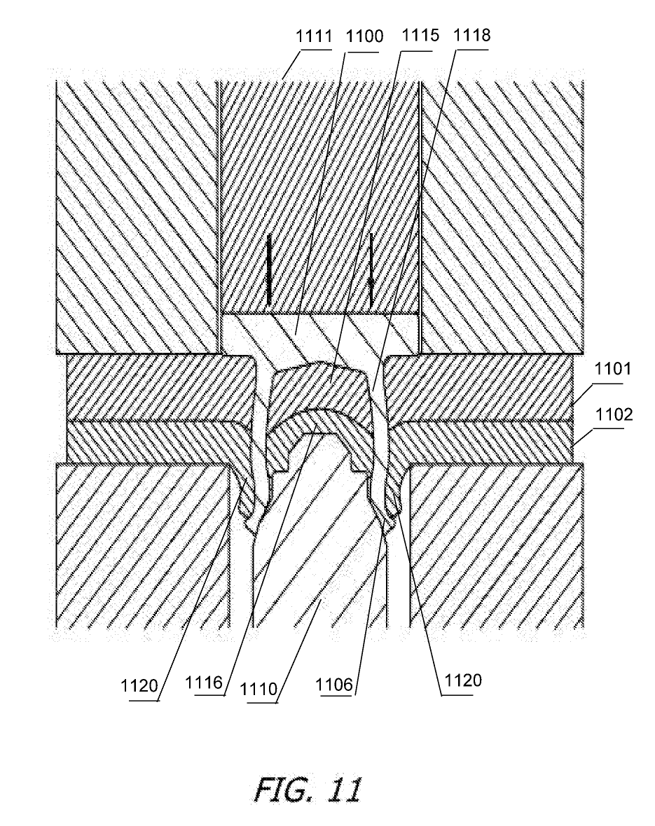

FIG. 11 shows a cross section of an installation step when using an embodiment of the rivet system. In an embodiment, as a plunger 1111 continues to push a rivet 1100. In an embodiment, a head portion 1110 of an installation anvil pushes a slug 1115 and a slug 1116 even further into a cavity of a hollow body of the rivet 1100. In an embodiment, the slug 1115 forms close contacts with internal surfaces of the cavity of the hollow body. In an embodiment, the slug 1116 forms close contacts with the slug 1115 and a wall 1118 of the hollow body. In an embodiment, the slugs 1115 and 1116 is substantially retained in the cavity of the hollow body of the rivet 1100 when the joining process ends. In an embodiment, the cavity filled with the slugs 1115, 1116 improves a shear strength of a joint. In an embodiment, the wall 1118 of the hollow body continues to bow outwardly as the wall 1118 experience a greater resistance while its moving along a surface of the head portion 1110 of the installation anvil. In an embodiment, material of a top 1101 and material of a bottom 1102 work pieces fill into a curvature of the rivet's wall 1118 to increase retention characteristics of the joint. In an embodiment, regions 1120 of the bottom work piece 1102, which are pushed away from the head portion 1110 of the installation anvil, form close contact with the wall 1118. In an embodiment, as the wall 1118 moves along the surface of the head portion 1110 of the installation anvil, an end 1106 continues to experience an outward flair, forming a retention curvature. In an embodiment, a geometry of the outward flair depends on a design of the head portion 1110, a design of the end 1106 and or characteristics of the regions 1120 of the bottom work piece 1102. In an embodiment, the head portion 1110 of the installation anvil is designed to cause an outward rollover or stretching of the end 1106. In an embodiment, the outward flair and or the outward rollover increases a tensile strength of a joint.

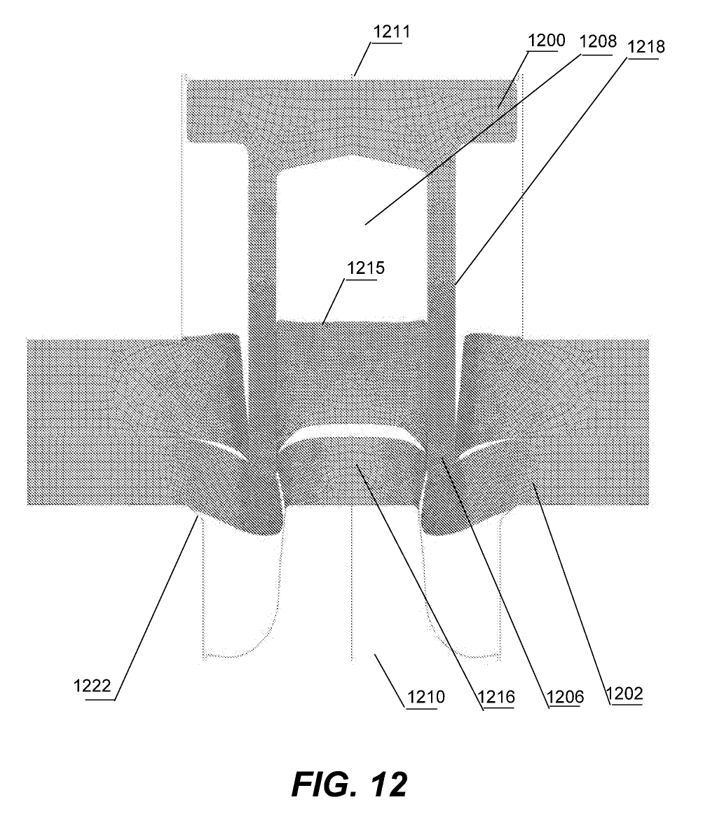

FIG. 12 shows a cross section of an installation step when using an embodiment of the rivet system. In an embodiment, as a plunger 1211 continues to push a rivet 1200. In an embodiment, a head portion 1210 of an installation anvil has a flat top side. In an embodiment, the head portion 1210 pushes a slug 1215 and a slug 1216 even further into a cavity 1208 of a hollow body, as the rivet 1200 moves downward. In an embodiment, the wall 1218 of the hollow body possesses a higher tensile strength than a material of a bottom work piece 1202 and, therefore, remains in a substantially straight shape after the rivet pierces through the bottom work piece. A bottom holding die has a corner 1222 designed as a circular ramp.

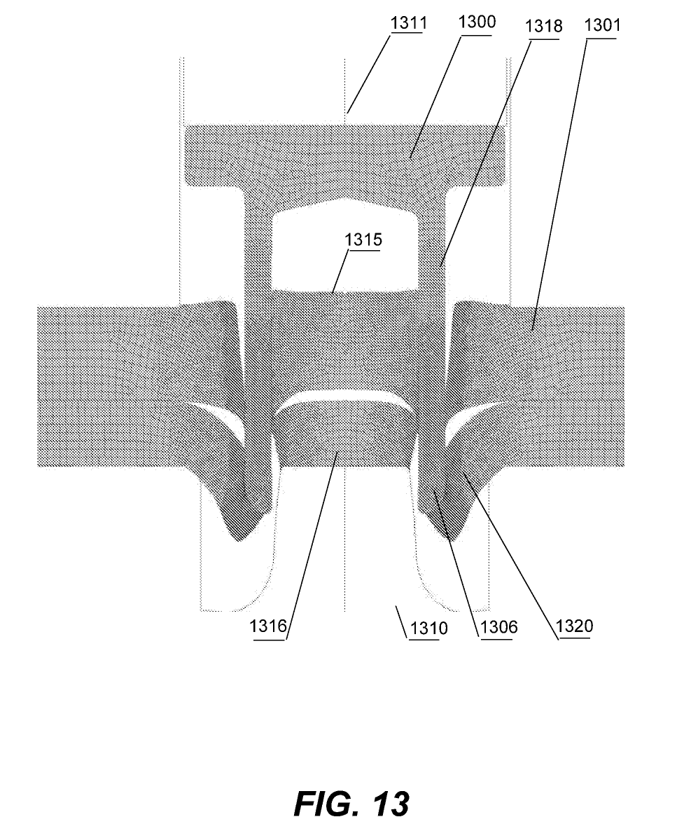

FIG. 13 shows a cross section of an installation step when using an embodiment of the rivet system. In an embodiment, as a plunger 1311 continues to push a rivet 1300. In an embodiment, a head portion 1310 of an installation anvil has a flat top side. In an embodiment, the head portion 1310 pushes a slug 1315 and a slug 1316 even further into a cavity of a hollow body, as the rivet 1300 moves downward. In an embodiment, a design of an end 1306 directs a movement of material in regions 1320 of a bottom work piece which are adjacent the wall 1318, resulting in the movement of at least some portion of the regions 1320 around the end 1306 as the rivet 1300 moves downward. The wall 1318 remains in a substantially straight shape as the rivet 1300 moves downward.

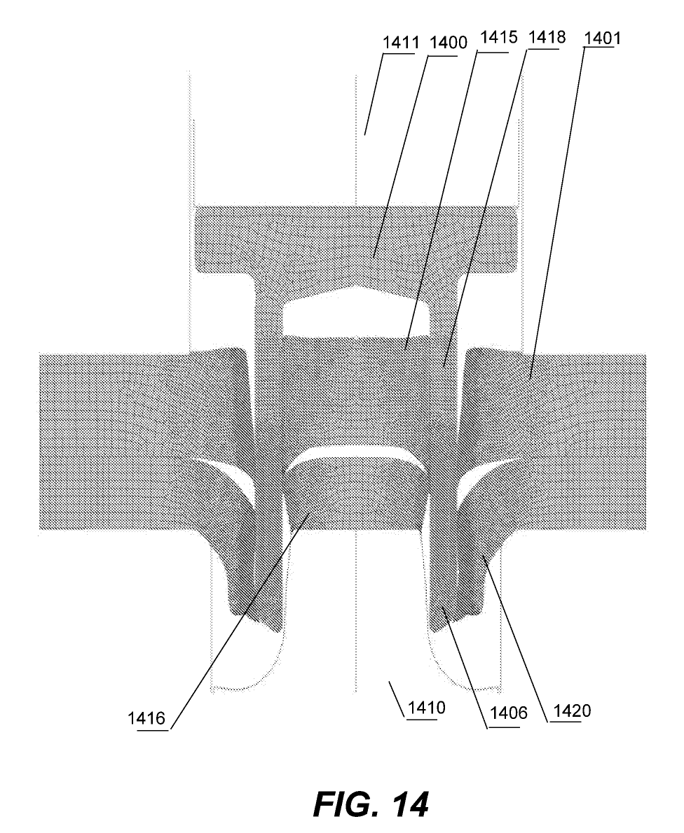

FIG. 14 shows a cross section of an installation step when using an embodiment of the rivet system. In an embodiment, as a plunger 1411 continues to push a rivet 1400. In an embodiment, a head portion 1410 of an installation anvil has a flat top side. In an embodiment, as the rivet 1400 moves downward, the head portion 1410 pushes a slug 1415 and a slug 1416 even further into a cavity of a hollow body of the rivet 1400. In an embodiment, the wall 1418 of the hollow body remains in a substantially straight shape as the rivet 1400 moves further along the head portion 1410 of the installation anvil. In an embodiment, the head 1410 of the installation anvil is designed to prevent substantial resistance between surface of the head 1410 and surface of the wall 1418, as the wall 1418 travels a certain distance along the head portion 1410. In an embodiment, the avoidance of the substantial resistance between the surface of the wall 1418 and the surface of the head portion 1410 maintains the shape of the wall 1418 in a substantially straight form.

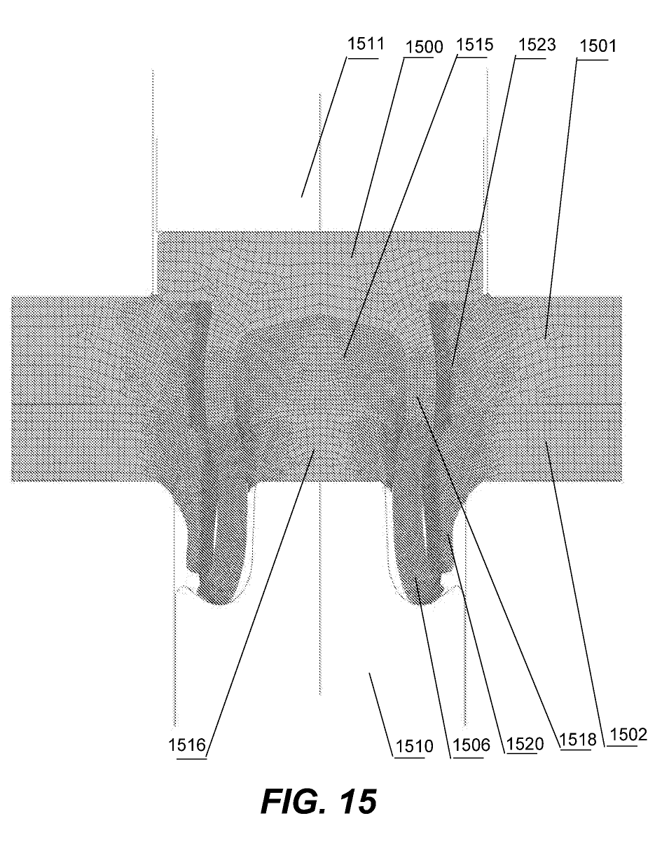

FIG. 15 shows a cross section of an installation step when using an embodiment of the rivet system. In an embodiment, as a plunger 1511 continues to push a rivet 1500. In an embodiment, a head portion 1510 of an installation anvil has a flat top side. In an embodiment, as the rivet moves downward, the head portion 1510 pushes a slug 1515 and a slug 1516 further into a cavity of a hollow body of the rivet 1500. In an embodiment, upon being pressed by the head portion 1510 of the installation anvil, the slugs 1515, 1516 form close contacts with surfaces of the cavity and each other by fittingly filling at least a portion of the cavity. In an embodiment, the slugs 1515 and 1516 is substantially retained in the cavity of the hollow body of the rivet 1500 when the joining process ends. In an embodiment, the head 1510 of the installation anvil is designed to force an end 1506 of a wall 1518 of the hollow body of the rivet 1500 to bow outward. As the rivet is being set, at least a portion of the wall 1518 is forced to change its shape to adopt a close fit between the at least some portions of the wall 1518, the slugs 1515, 1516, and regions 1523, 1520 of a top 1501 and a bottom 1502 work pieces which are adjacent to the wall 1518. In an embodiment, at least the portion of the wall 1518 changes its shape to form sequential areas of outward and inward deformities with respect to the cavity of the hollow body of the rivet 1500.

What is claimed is:

1. A rivet system comprising:
(a) a rivet to join at least a first and a second work pieces;
wherein the rivet having a hollow body portion and a head portion;
wherein the hollow body portion having a first and a second ends;
wherein the head portion is positioned at the first end of the hollow body portion;
wherein the second end of the hollow body of the rivet faces the first work piece;
wherein the hollow body near the second end is sufficiently designed to pierce work pieces during a joining process;
(b) an installation anvil having a head portion;
wherein the head portion of the installation anvil is sufficiently designed so that, when the rivet is pushed toward the work pieces, to push a slug from each work piece into a cavity of the hollow body of the rivet; and
wherein the slugs are composed of portions of the first and the second work pieces which are pierced through by the second end of the hollow body of the rivet during the joining process.

2. The rivet system of claim 1, wherein the head portion of the installation anvil is sufficiently designed so that, when the second end of the hollow body of the rivet pierces the second work piece, the head portion of the installation anvil forces the second end of the hollow body to change its shape.

3. The rivet system of claim 1, wherein the installation anvil is stationary.

4. The rivet system of claim 1, wherein the second end of the hollow body of the rivet is narrowed at an angle to create a pointed ending.

5. The rivet system of claim 1, wherein the rivet system further comprising a plunger which presses onto the head of the rivet, forcing the rivet to pierce the work pieces.

6. The rivet system of claim 1, wherein the rivet system further comprising a top and a bottom holding dies which clam the work pieces together during the joining process.

7. The rivet system of claim 4, wherein the rivet system further comprising a top and a bottom holding dies which clam the work pieces together during the joining process.

8. The rivet system of claim 6, wherein the head portion of the installation anvil extends towards the work pieces beyond a boundary of the bottom holding dies.

9. The rivet system of claim 1, wherein the hollow body of the rivet is sufficiently designed to outwardly bow during the joining operation.

10. The rivet system of claim 1, wherein the rivet is made from a material whose tensile strength is higher than tensile strength of the first and second work pieces.

11. The rivet system of claim 1, wherein at least a portion of a wall of the hollow body of the rivet is sufficiently designed so that, when the wall is being pressed on by the slugs or the head portion of the installation anvil, the wall changes its shape to form sequential areas of outward and inward deformities with respect to the cavity of the hollow body.
